(19) United States
(12) Patent Application Publication
(10) Pub. No.: US 2020/0021207 A1
(43) Pub. Date: Jan. 16, 2020

(54) Power Semiconductor Circuit

(71) Applicant: Siemens Aktiengesellschaft, München (DE)

(72) Inventors: Albrecht Donat, Dachsbach (DE); Gerhard Heinemann, Erlangen (DE); Frank Ibach, Berg b. Neumarkt i. d. Oberpfalz (DE); Franz Imrich, Erlangen (DE); Roland Lorz, Röttenbach (DE); Jens Weidauer, Fürth (DE); Thomas Jungwirth, Forchheim (DE); Lutz Namyslo, Hausen (DE)

(73) Assignee: Siemens Aktiengesellschaft, München (DE)

(21) Appl. No.: 16/483,412

(22) PCT Filed: Jan. 9, 2018
(86) PCT No.: PCT/EP2018/050390

§ 371 Date: Aug. 3, 2019

(30) Foreign Application Priority Data
Feb. 3, 2017 (EP) 17154499.2

(51) Int. Cl. H02M 7/5387; H02M 1/088

(52) U.S. Cl. CPC H02M 7/53871; H02M 2001/0009; H02M 1/088

(57) ABSTRACT

Various embodiments include a power semiconductor circuit comprising: two DC voltage terminals; a half-bridge connected between the DC voltage terminals, the half-bridge including two series-connected switchgear units; an AC voltage terminal associated with the half-bridge; a gate-driver circuit associated with each of the switchgear units; a commutation capacitor parallel to the half-bridge; a module controller; and a meter for determining the current to the AC voltage terminal. Each switchgear unit comprises a respective power semiconductor switch or a plurality of parallel-connected power semiconductor switches. The half-bridge, the commutation capacitor, and the gate-driver circuit are arranged on a common homogeneous circuit carrier.

### CROSS-REFERENCE TO RELATED APPLICATIONS

This application is a U.S. National Stage Application of International Application No. PCT/EP2018/050390 filed Jan. 9, 2018, which designates the United States of America, and claims priority to EP Application No. 17154499.2 filed Feb. 3, 2017, the contents of which are hereby incorporated by reference in their entirety.

### TECHNICAL FIELD

The present disclosure relates to power circuits. Various embodiments may include power semiconductor circuits with two DC voltage terminals and at least one half-bridge which is connected between the DC voltage terminals.

### BACKGROUND

Power converters require semiconductor switches, for example transistors, with a sufficiently high current-carrying capacity and blocking voltage so that an electrical power in the kilowatt upwards range can be switched with the smallest possible number of semiconductor switches. These semiconductor switches are generally combined to form “power semiconductor modules”. In power semiconductor modules, the semiconductor switches are typically arranged side by side on a common, thermally conductive carrier. Bonding wires wire the individual semiconductor switches to terminals via which the power semiconductor module is interconnected with peripheral units. Operating such a power semiconductor module entails connecting, for example, a circuit board on which a gate-driver circuit for switching the semiconductor switch is provided for each semiconductor switch. The power semiconductor module must also be mounted on a heat sink in order to dissipate the heat which accumulates in the described carrier away from the power semiconductor module.

The compact, block-like design and the necessity for external wiring with gate-driver circuits make it difficult to adapt a power semiconductor module to given power and installation space circumstances. As a result of the many possible applications for modern converter technology, however, differing power and installation space requirements have to be met depending the particular application while only a limited selection of power semiconductor modules are available. Accordingly, the limited number of available power semiconductor modules leads to the selection and use of those which are approximately suitable. If no suitable power semiconductor module is available for an application, use must be made of a suboptimal, oversized power semiconductor module which is an undesirably costly solution.

Furthermore, in power-electronic actuators with a relatively high power rating, the switches are constructed from parallel-connected semiconductor chips. In order to ensure that the chips switch virtually synchronously, they are arranged geometrically close to one another and structurally combined in specific modules. Outwardly, the modules behave in approximately the same way as one high-power chip. The variance of these modules is, however, very high and the degree of integration low. Each power-electronic actuator is therefore a unique item with very little reuse value with regard to the power-electronic subcomponents. This results in long development times and high maintenance costs.

### SUMMARY

The teachings of the present disclosure describe a power semiconductor circuit which reduces the above-stated disadvantages. For example, some embodiments include a power semiconductor circuit (100, 200, 300, 400) with two DC voltage terminals (102a, 102b), at least one half-bridge which is connected between the DC voltage terminals (102a, 102b), wherein the half-bridge comprises two series-connected switchgear units (104a, 104b, 301a, 301b, 302a, 302b), wherein each switchgear unit comprises a power semiconductor switch (104a, 104b, 301a, 301b, 302a, 302b) or a plurality of parallel-connected power semiconductor switches (104a, 104b, 401a, 401b, 402a, 402b), an AC voltage terminal (106) for each of the half-bridges, a gate-driver circuit (105a, 105b, 303a, 303b, 304a, 304b) for each of the switchgear units, a commutation capacitor (103, 203a, 203b) parallel to the half-bridge, a module controller (107), and a measurement device (113) for determining the current to the AC voltage terminal, wherein the half-bridge, the commutation capacitor (103, 203a, 203b) and the gate-driver circuit (105a, 105b, 303a, 303b, 304a, 304b) are arranged on a common homogeneous circuit carrier (101).

In some embodiments, there is precisely one half-bridge.

In some embodiments, there are precisely two parallel-connected half-bridges.

In some embodiments, there are precisely three half-bridges.

In some embodiments, the commutation capacitor (103, 203a, 203b) has a capacitance of at most 10 μF.

In some embodiments, there is a device (108) for measuring the voltage of the commutation capacitor (103, 203a, 203b).

In some embodiments, there is a device (109) for measuring temperature.

In some embodiments, the commutation capacitor (103, 203a, 203b) and the half-bridge or half-bridges are constructed as a commutation cell.

In some embodiments, there is an inductor (110) between the center point of each half-bridge and the AC voltage terminal (106).

In some embodiments, there is a second AC voltage terminal (112).

In some embodiments, there is a filter capacitor (111) between the AC voltage terminal (106) and the second AC voltage terminal (112).

In some embodiments, the power semiconductor switches are formed by IGBTs or MOSFETs.

In some embodiments, the power semiconductor switches (104a, 104b, 301a, 301b, 302a, 302b) are formed by wide-bandgap semiconductor switches, in particular GaN switches.

In some embodiments, the module controller (107) is designed such that it can carry out pulse-width modulation of the half-bridge with a phase and/or output frequency which can be externally specified to the module controller (107) via an interface.

In some embodiments, there is the module controller (107) has a serial interface (107a, 107b) for communication.

### BRIEF DESCRIPTION OF THE DRAWINGS

Various embodiments of the teachings herein are described below with reference to the schematic drawings in which:

FIG. 1 shows a circuit diagram for one embodiment of the power semiconductor circuit incorporating teachings of the present disclosure;

FIG. 2 shows the structure of the power semiconductor circuit according to FIG. 1;

FIG. 3 shows a circuit diagram for a second embodiment of the power semiconductor circuit incorporating teachings of the present disclosure;

FIG. 4 shows a circuit diagram for a third embodiment of the power semiconductor circuit incorporating teachings of the present disclosure;

FIG. 5 shows an arrangement of a plurality of modules to form a power converter incorporating teachings of the present disclosure; and

FIG. 6 shows a schematic structure of a module incorporating teachings of the present disclosure.

### DETAILED DESCRIPTION

In some embodiments, a power semiconductor circuit incorporating the teachings herein comprises two DC voltage terminals, at least one half-bridge which is connected between the DC voltage terminals, wherein the half-bridge comprises two series-connected switchgear units, wherein each switchgear unit comprises a power semiconductor switch or a plurality of parallel-connected power semiconductor switches, an AC voltage terminal for each of the half-bridges, a gate-driver circuit for each of the switchgear units, a commutation capacitor parallel to the half-bridge, a module controller and a measurement device for determining the current to the AC voltage terminal. At least the half-bridge, the commutation capacitor and the gate-driver circuit are here mounted on a common, homogeneous circuit carrier, for example an IMS (Insulated Metal Substrate), an FR4 printed circuit board or a DCB (Direct Copper Bond) ceramic.

As a result, a power semiconductor circuit which can be put to more general use than known power semiconductor modules is obtained. In some embodiments, the power semiconductor circuit can be used individually or interconnected with further similar power semiconductor circuits. Interconnected use increases the power provided. A converter can, for example, be constructed from a plurality of power semiconductor circuits incorporating the teachings herein. The gate-driver circuits may be already part of the power semiconductor circuit, so shortening switching paths and thus reducing parasitic inductance. Thanks to the module controller, which makes use of the measurement device for determining current, the power semiconductor circuit may be more autonomous in operation than known power semiconductor modules.

The embodiments described above can be combined with the features of one of the variants described below. The following features may accordingly additionally be provided for the current converter:
The power semiconductor circuit may be constructed such that it comprises precisely one half-bridge. The power semiconductor circuit is then designed for single-phase operation and can convert a DC voltage applied to the DC voltage terminals via the half-bridge into a PWM-modulated AC voltage and output it at the AC voltage terminal. A multi-phase overall structure is achievable with such a power semiconductor circuit, for example by connecting three power semiconductor circuits in parallel to the DC voltage terminals and using the AC voltage terminals of the power semiconductor circuits as the three phases of a three-phase output voltage. The structure of the power semiconductor circuit with precisely one half-bridge is advantageously slim and permits the greatest flexibility for constructing relatively complex overall circuits and the smallest installation space, if for example only a single-phase overall circuit is to be constructed. Even if precisely one half-bridge is present, it may comprise an individual power semiconductor switch or a parallel connection of a plurality of semiconductor switches in each of the two switchgear units of the half-bridge.
The power semiconductor circuit may be constructed such that it comprises precisely two half-bridges. These may be connected in parallel. As a result, a full bridge is obtained in the power semiconductor circuit. Said bridge may for example be used not only in constructing a DC/DC converter but also for other electrical converters.
The power semiconductor circuit may be constructed such that it comprises precisely three half-bridges. These may be connected in parallel. The half-bridges are again arranged on the common printed circuit board. The power semiconductor circuit is then designed for three-phase operation and can convert a DC voltage applied to the DC voltage terminals via the half-bridges into a PWM-modulated three-phase AC voltage and output it at the three AC voltage terminals. In comparison with the single-phase power semiconductor circuit, the structure of the power semiconductor circuit with precisely three half-bridges is optimized with regard to installation space for three-phase overall circuits and thus enables three-phase overall circuits with a smaller volume. At the same time, actuation of the switchgear units is simplified since the module controller can set the phase angle of the pulse-width modulation for the three-phase output voltage without external communication.
The commutation capacitor may have a capacitance of at most 10 μF. As a result, a comparatively small capacitor can be used. The purpose of the commutation capacitor is to provide and construct a commutation cell with the half-bridge or half-bridges of the power semiconductor circuit. In an overall circuit, which for example constitutes a converter, it is therefore possible to select an optimum capacitor for constructing a DC link; thanks to short current paths, the structure of the power semiconductor circuit or power semiconductor circuits furthermore ensures optimum commutation with low parasitic inductance during switching operations. The maximum capacitance of the commutation capacitor is here coordinated with the maximum operating voltage, i.e. the blocking ability of the power semiconductor switches used.
The power semiconductor circuit may include a device for measuring the voltage of the commutation capacitor, wherein this device is conveniently also integrated on the common printed circuit board. Measurement of the voltage provides the module controller with a further input value which can be used for controlling the power semiconductor circuit. As a result, the module controller is more autonomous and flexible and is for example capable of responding better to incorrect operating situations such as an absent or excessively high input voltage.
The power semiconductor circuit may comprise a device for measuring temperature which is conveniently also integrated on the common printed circuit board. The device for measuring temperature may for example comprise an NTC measuring shunt such as a KTY or platinum measuring element, for example a Pt100 or Pt1000 measurement sensor. This advantageously enables error states of the power semiconductor circuit or also of the surroundings of the power semiconductor circuit to be identified. As a result, the module controller is more autonomous and can for example reduce or prevent damage to the power semiconductor switches in the event of exposure to excessively high temperatures. It is furthermore possible for the module controller to determine and output an estimated service life, for example by summing temperature exposure over operating periods and drawing a conclusion as to the residual service life of the power semiconductor switch on the basis of the cumulative temperature exposure. It is advantageous for the device for measuring temperature to be arranged in the immediate vicinity of the half-bridge, in particular between the switchgear units of the half-bridge, such that the input of heat from the power semiconductor switches can be quickly and directly measured.
The power semiconductor circuit may include a decoupling inductor between the center point of one or all of the half-bridges and the associated AC voltage terminal, so enabling parallel connection of a plurality of the power semiconductor circuits. The magnitude of the decoupling inductance is dependent on the actuation jitter, DC link voltage, load current and admissible dynamic current asymmetry. If, for example, jitter is 50 ns, the DC link voltage 480 V, the load current 35 A and asymmetry 5%, a decoupling inductance of 20 pH is convenient. The magnitude of the decoupling inductance preferably amounts to between 2 μH and 50 μH, so covering a current and voltage range from 20 A to 200 A and between 380 V and 690 V.
The power semiconductor circuit may have a second AC voltage terminal. This may serve, for example, to create a cross-connection to an AC voltage terminal of a further power semiconductor circuit. In particular, the power semiconductor circuit may have a filter capacitor between the AC voltage terminal and the second AC voltage terminal, so advantageously permitting filtering of the output voltage even in the event of interconnection of a plurality of the power semiconductor circuits.
Two, in particular precisely two, AC voltage terminals may also be present in a power semiconductor circuit with two or three half-bridges. The power semiconductor circuit may for example be used as a phase module, in which the three half-bridges are synchronously actuated and so correspond to just one phase in the overall structure. A second AC voltage terminal may then also be used for a cross-connection of a plurality of power semiconductor circuits.
The power semiconductor circuit may have a third DC voltage terminal. This may provide a connection to a neutral conductor, a ground potential or a center point potential of an externally arranged DC link. This potential may also be put to use in the power semiconductor circuit, for example to carry out a modified pulse-width modulation, thus for example an operating mode of a multi-stage converter. In this case, the commutation capacitor may be connected in series to a second commutation capacitor, wherein the potential point between the two commutation capacitors is connected to the third DC voltage terminal. The commutation capacitors may again form a commutation cell with the half-bridge.
The third DC voltage terminal may be connected via a bipolar switch to the center point of the half-bridge. The potential predetermined by the third DC voltage terminal may thus also be used for the AC voltage.
The power semiconductor circuit may be configured in such a manner that the two or three DC voltage terminals and the one, two or three AC voltage terminals are the only load terminals to be present. The power semiconductor circuit thus forms a self-contained component similar to the power semiconductor modules with substantially extended functionality.
The power semiconductor switches may for example take the form of IGBTs or MOSFETs. The power semiconductor switches may take the form of wide-bandgap semiconductor switches, in particular GaN switches or SiC switches. IGBTs and MOSFETs are known for this application. GaN switches, for example as a HEMT or cascode, are not yet in widespread use, but offer distinct advantages with regard to the usable switching frequency range and with regard to power loss. In contrast with pure silicon-based semiconductor switches, wide-bandgap semiconductor switches can be switched at a higher switching frequency.
The module controller may have a serial interface for communication. Communication with a setpoint encoder is for example possible via the interface. The interface accepts actuation commands in the setpoint direction. Communication may here proceed via actuation with an individual signal value, since a plurality of different control values, such as for example frequency and phase angle of an AC voltage to be generated, can also be transferred via the interface. The interface may also be configured bidirectionally such that the module controller can also return values. For example, the module controller can return values for current, voltage, temperature and information about switching behavior, such as for example switching times. The module controller more preferably comprises a microprocessor and a memory for this purpose. The interface furthermore also allows a plurality of the power semiconductor circuits to communicate with one another.
The module controller may be designed such that it can carry out pulse-width modulation of the half-bridge with a phase and/or output frequency which can be externally specified to the module controller via the interface. The power semiconductor circuit thus acts as a smart device which does not require precise electrical actuation but may instead be actuated with abstract setpoints.
The module controller may be designed to use a frequency of at least 2 kHz, at least 10 kHz or at least 30 kHz for switching the switchgear units.
It may be convenient for the load terminals likewise to be arranged on the common printed circuit board. It may be likewise convenient for the module controller and the measurement device for determining current to be arranged on the common printed circuit board.
The commutation capacitor may also consist of a plurality of capacitors, for example connected in series or parallel. The capacitance of the commutation capacitor then corresponds to the total capacitance of these capacitors. In some embodiments, there may be no capacitor which is specified for the required current and/or the required voltage.
The control lines between a gate-driver circuit and the power semiconductor switch(es) of the associated switchgear unit may take the form of a respective conductor track on the common printed circuit board. As a result, it is not necessary, other than in the case of a compact power semiconductor module, to interconnect the gate-driver circuit with the power semiconductor switches by bonding. This additionally reduces the parasitic inductance which impairs the maximum possible switching frequency.
The semiconductor switches may in each case be mechanically and electrically connected without wires to the conductor tracks via a solder layer. In other words, the semiconductor switches may not be designed, for example, as a discrete component with pins which are inserted into and soldered to the printed circuit board. Each semiconductor switch may be instead located on the conductor tracks and is soldered thereon via a solder layer, i.e. a layer of tin-lead solder. This results in a geometrically particularly short link and consequently low parasitic inductance. Each semiconductor switch may accordingly be switched at a relatively high switching frequency without this resulting in an overvoltage being induced.
The common printed circuit board may have a metal substrate and may for example be an IMS (Insulated Metal Substrate). This gives rise to the advantage that, despite the high switching frequencies, the semiconductor switches can be cooled via the metal, such that both the conductor tracks and the semiconductor switches can be cooled using one and the same cooling technology by dissipation of the waste heat via the metal. A more inexpensive variant provides a printed circuit board based on a polymer, for example based on epoxy resin or glass fiber mats which are impregnated in epoxy resin. Use of a polymer ensures particularly high tracking resistance. In addition, a lower parasitic capacitance is achieved than when a metal substrate is used, which in particular at an elevated switching frequency results in a lower leakage current.

In the present disclosure, the described components of any given embodiment are in each case individual features of the teachings herein and to be considered independently of one another, which in each case also mutually independently further develop the concepts and are therefore to be considered part of the teachings either individually or in a combination other than that indicated. The described embodiment can furthermore also be supplemented by further, previously described features. In the figures, elements of identical function are provided with the same reference numerals.

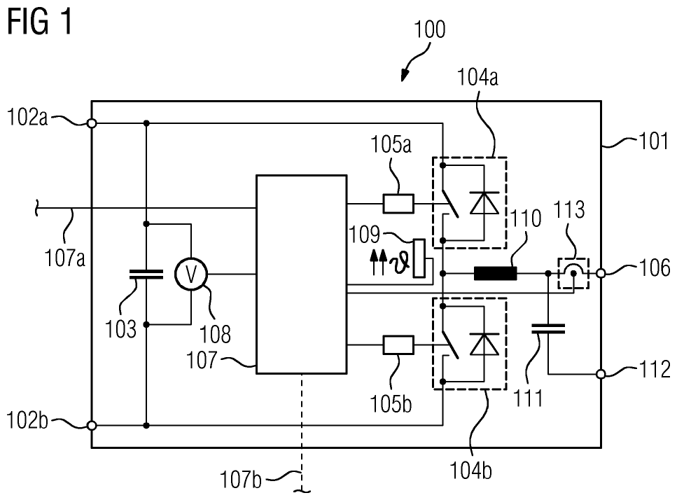

FIG. 1 shows a circuit diagram of a first embodiment of the power semiconductor circuit incorporating the teachings herein. The first module 100 comprises a printed circuit board 101. In this embodiment, the printed circuit board 101 is an IMS, but may also be an FR4 material or a DCB ceramic. The first module 100 comprises two DC voltage terminals 102a, 102b together with an AC voltage terminal 106 and a further AC voltage terminal 112 as load terminals for connection to further power-electronic components. In FIG. 1, these are shown as being located at the edge of the printed circuit board 101 but in the actual implementation need not be located at the edge or on opposing sides of the printed circuit board 101.

Further elements of the first module 100 which are arranged on the printed circuit board 101 include a commutation capacitor 103, a voltage converter 108, a module controller 107 in the form of a microprocessor, a half-bridge with two IGBTs 104a, 104b and two associated gate-driver circuits 105a, 105b, a temperature sensor 109, a filter inductor 110 and a filter capacitor 111 and a current converter 113.

The commutation capacitor 103 is shown connected between the two DC voltage terminals 102a, 102b. In some embodiments, the commutation capacitor 103 may comprise a plurality of capacitor components. In the present example, the commutation capacitor 103 has a capacitance of 36 nF.

The capacitance C of the commutation capacitor 103 may be determined as follows from the maximum load current I, the commutation inductance Lₖ acting in the commutation circuit, the voltage U_{CE} and the DC link voltage U_{DC}:

$$C = \frac{{I}^{2} {L}_{k}}{{( {U}_{CE} - {U}_{DC} )}^{2}}$$

The maximum current I=200 A, inductance Lₖ=40 nH, collector-emitter voltage U_{CE}=900 V and DC link voltage U_{DC}=690 V result in a capacitance C of 36 nF.

In some embodiments, the voltage converter 108 is connected in parallel to the commutation capacitor 103. The voltage converter 108 is connected to the module controller 107 and allows the module controller 107 to take account of the state of charge of the commutation capacitor 103 during actuation of the half-bridge.

In some embodiments, the module controller 107 has two interfaces. A serial interface 107a serves for data exchange with an external, higher-level controller. This data exchange may be, for example, the allocation of setpoints from the higher-level controller to the module controller 107. Such a setpoint may be, for example, a phase angle or amplitude of an AC voltage to be output. The setpoint is here abstract, i.e. it is independent of the specific actuation which is required for the IGBTs 104a, 104b of the half-bridge necessary in order actually to achieve the setpoints. Implementation of the abstract setpoints in a specific actuation of the IGBTs 104a, 104b, for example in the form of a suitable pulse-width modulation, is carried out by the module controller 107.

A further interface 107b may serve for connection with a module controller of further circuits which are constructed like the first module 100. The module controllers 107 can exchange operating data via the further interface 107b and so organize the voltage conversion internally and independently of the higher-level controller.

The module controller 107 may be furthermore connected to the gate-driver circuits 105a, 105b and actuates them to switch the IGBTs 104a, 104b, for example in a pulse-width modulation switching pattern. The gate-driver circuits 105a, 105b are to this end connected via suitable, maximally short control lines to the gate contacts of the IGBTs 104a, 104b.

The IGBTs 104a, 104b may be connected in the same direction in series and thus form a half-bridge. The half-bridge is connected between the DC voltage terminals 102a, 102b and thus parallel to the commutation capacitor 103. The center point of the half-bridge is connected to the filter inductor 110, wherein the second terminal of the filter inductor 110 is connected to the AC voltage terminal 106. A current converter 113 is arranged in the line region between AC voltage terminal 106 and filter inductor 110. The second terminal of the filter inductor 110 is furthermore connected via the filter capacitor 111 to the further AC voltage terminal 112.

A temperature sensor 109, for example in the form of a platinum resistor, may be arranged in the region between the two IGBTs 104a, 104b, i.e. between their actual position on the printed circuit board 101. The temperature sensor 109, like the current converter 113, is connected to the module controller 107. The module controller thus has at its disposal values for output current, input voltage and temperature in the region of the half-bridge in order suitably to control the IGBTs 104a, 104b and, if need be, output messages regarding fault scenarios via the serial interface 107a.

The filter with the filter inductor 110 may limit dU/dt voltage changes and furthermore to reduce harmonics to a pure output voltage sine wave. This may be advantageous when wide-bandgap switches such as for example GaN switches with very high switching frequencies, for example in the MHz range, are used and as a result the filter elements can be made very small and be simply integrated in the module 100.

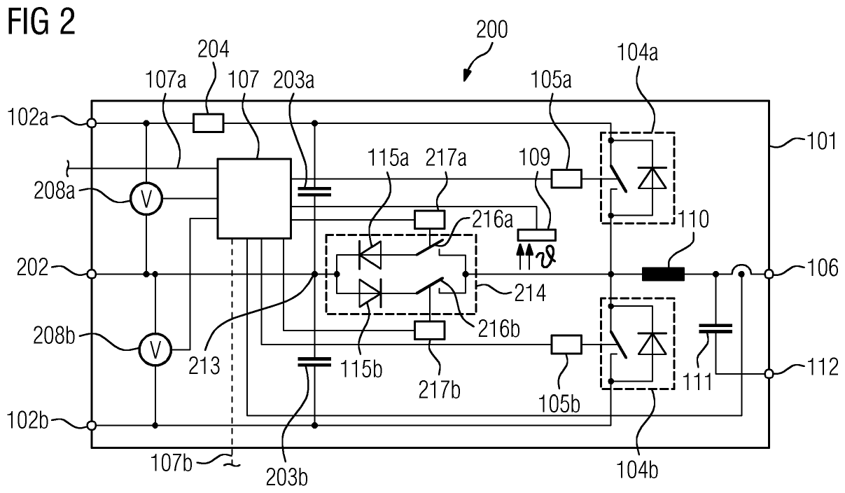

FIG. 2 shows a circuit diagram of a second embodiment of the power semiconductor circuit incorporating the teachings herein. The second module 200 largely comprises the components of the first module 100, wherein some elements are replaced or supplemented. The second module 200 has a third DC voltage terminal 202.

The third DC voltage terminal 202 may for example provide a connection to a neutral conductor, a ground potential or a center point potential of an externally arranged DC link. Instead of the voltage terminal 108, two voltage converters 208a, 208b are now provided which sense the voltage between each one of the DC voltage terminals 102a, 102b and the third DC voltage terminal 202 and forward it to the module controller 107. The single commutation capacitor 103 is replaced by a series arrangement of first and second commutation capacitors 203a, 203b which are connected between the DC voltage terminals 102a, 102b. The potential point 213 between the two commutation capacitors 203a, 203b is connected to the third DC voltage terminal 202.

A bipolar switch 214 may be connected between the potential point 213 and the center point of the half-bridge. The bipolar switch 214 comprises a parallel connection of two series circuits, wherein the series circuits each include a diode 215a, 215b and an IGBT 216a, 216b. A gate-driver circuit 217a, 217b is provided for each of the two IGBTs 216a, 216b.

In some embodiments, there is a damping resistor 204 in the connection between the first commutation capacitor 203a and the DC voltage terminal 102a. This serves to damp oscillations which arise in the oscillator circuit made up of the commutation capacitors 203a, 203b and externally connected DC link capacitors and the line inductors. The damping resistor 204 may also be arranged between the commutation capacitors 203a, 203b or between the second commutation capacitor 203b and the DC voltage terminal 102b. The further elements of the first module 100 are also present in the second module 200.

The second module 200 thus permits operation in the manner of a three-point inverter, in which a medium voltage level of the DC link is also used in the pulse-width modulation in order to achieve improved modulation of the AC voltage and thus a reduction in the necessary filters. The module controller 107 is therefore designed, in addition to the IGBTs 104a, 104b of the half-bridge, also to actuate the IGBTs 216a, 216b of the bipolar switch 214 via the respective gate-driver circuits 105a, 105b, 217a, 217b. To this end, setpoints and measured values are sensed and processed as in the first module 100, wherein an additional voltage value is available due to the third DC voltage terminal 202.

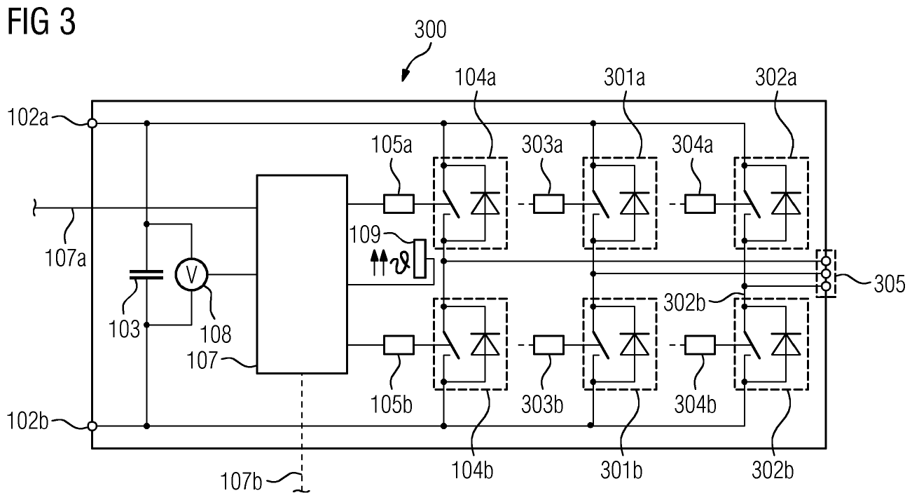

The first and second modules 100, 200 are single-phase circuits. FIG. 3 shows a circuit diagram of a third embodiment of the power semiconductor circuit incorporating the teachings herein. The third embodiment as shown is directly designed and optimized for three-phase applications. The third module 300 here again comprises some elements of the first module 100 which are again provided with identical reference numerals. The third module 300 also comprises additional elements and further elements of the first module 100 are not present in the third module 300.

The third module 300 comprises two further half-bridges which are connected in parallel to the half-bridge which was already present in the first module 100. The second half-bridge comprises two series-connected IGBTs 301a, 301b and the third half-bridge comprises two series-connected IGBTs 302a, 302b. The additional IGBTs 301a, 301b, 302a, 302b have control lines to gate-driver circuits 303a, 303b, 304a, 304b, via which they are actuated by the module controller 107.

The third module 300 comprises three AC voltage terminals 305, of which a first is connected to the center point of the first half-bridge, a second to the center point of the second half-bridge and a third to the center point of the third half-bridge. The filter inductor 110 and filter capacitor 111 are not present in the third module 300 according to this embodiment, but may be present in other embodiments in order to output a filtered AC voltage at the AC voltage terminals. A current converter is provided in the current path to each of the AC voltage terminals 305 but is not shown in FIG. 3 for reasons of clarity.

The third module thus permits output for example of a three-phase AC voltage, wherein a higher-level controller may again predetermine abstract setpoints relating to the AC voltage such as phase angle, frequency and/or amplitude. The module controller 107 may also be designed such that the three AC voltage signals which are generated are not phase-shifted by 120° to one another, but are instead generated with a freely selectable phase shift. For example, all three AC voltage signals can be generated in-phase.

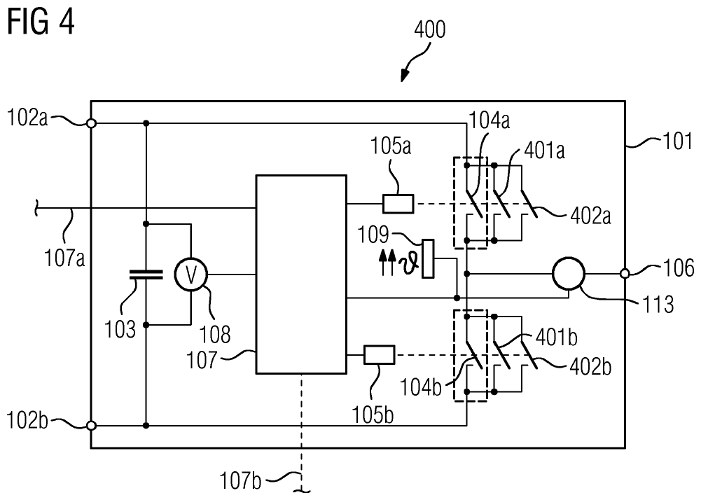

FIG. 4 shows a circuit diagram of a fourth embodiment of the power semiconductor circuit incorporating the teachings herein. The fourth embodiment is here again designed for single-phase applications, wherein, as in the other single-phase modules 100, 200, interconnection of a plurality of the modules 100, 200 is possible in order to provide a three-phase structure. The fourth module 400 according to FIG. 4 here again comprises some elements of the first module 100 which are again provided with identical reference numerals. The fourth module 400 also comprises additional elements. Some elements of the first module 100 are not present in the fourth module 400.

In the fourth module 400, two further IGBTs 401a, 402a are provided parallel to IGBT 104a and parallel to one another. The additional IGBTs 401a, 402a are actuated via the gate-driver circuit 105a which is already present for IGBT 104a from the first module 100. In a similar manner, two further IGBTs 401b, 402b are present parallel to IGBT 104b. The additional IGBTs 401b, 402b are actuated via the gate-driver circuit 105b. For greater clarity, IGBTs 104a & b, 401a & b and 402a & b are shown in FIG. 4 without their internal diodes.

Unlike the first module 100, the fourth module 400 has no filter inductor 110 and no filter capacitor 111 and no further AC voltage terminal 112. It is possible for the fourth module 400 to be constructed with a printed circuit board 101 which has prefabricated mounting spaces for the filter inductor 110 and the filter capacitor 111. In this case, the mounting space for the filter inductor 110 is electrically through-connected with a suitable component and the mounting space for the filter capacitor 111 is not occupied and thus electrically severed. While the further AC voltage terminal 112 can indeed likewise be present on the printed circuit board 101, for example as a screw terminal, it has no electrical function in the absence of a component for the filter capacitor 111.

Due to the parallel connection of the additional IGBTs 401a & b, 402a & b, the power range of the circuit is extended correspondingly with the number of additional power semiconductors. In this case too, mounting spaces may be provided for the power semiconductors which, depending on the desired power of the fourth module 400, are populated or left unoccupied.

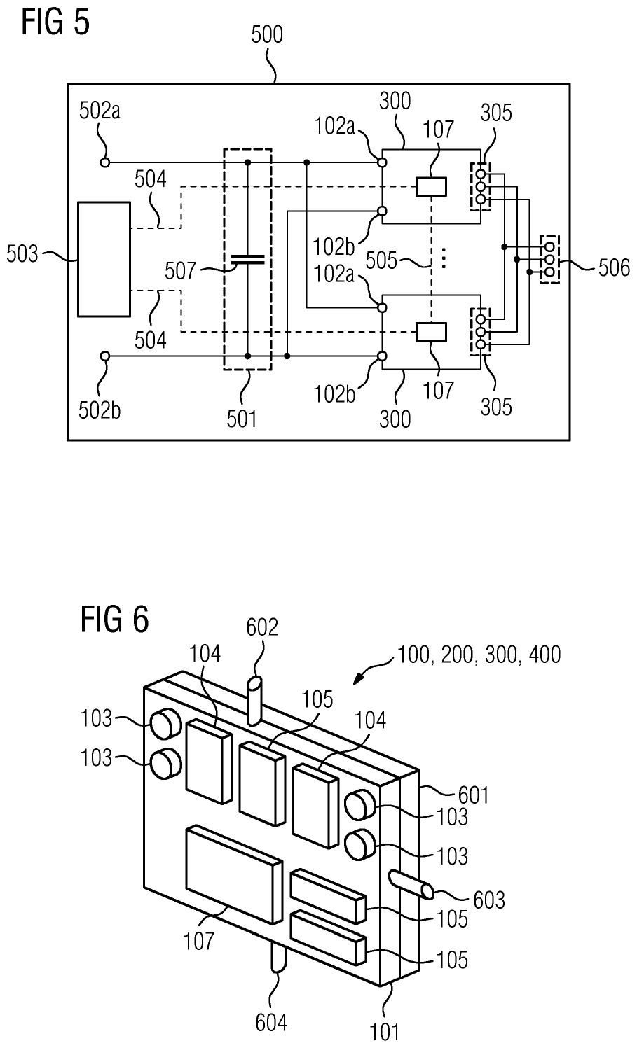

FIG. 5 shows the arrangement of a plurality of modules 300 to form a power converter 500. The power converter 500 comprises first terminals 502a, 502b for connection to a DC voltage system which may be, for example, not only a DC voltage source but also a load. A DC link 501 with a link capacitor 507 is connected between the first terminals 502a, 502b. The link capacitor 507 is designed, with regard to its capacitance, for the entire power converter and therefore has a higher capacitance than the commutation capacitors 103 of the individual modules 300.

The power converter 500 comprises a plurality of modules 300, two of which are shown in FIG. 5. The power converter 500 can actually comprise any number of modules 300, wherein the modules 300 are conveniently two, three, four, five or six in number. The modules 300 are connected parallel to one another with the DC link, i.e. the first DC voltage terminals 102a with the first terminal 502a and the second DC voltage terminals 102b with the second terminal 502b.

The power converter 500 furthermore comprises a power converter controller 503 which is connected via control lines 504 to the module controllers 107. The module controllers 107 are in turn connected to one another by cross-connections 505. The cross-connections 505 are here optional, since a star connection scheme using only the control lines 504 is also possible. A further alternative involves using just one control line 504 and the control commands being forwarded via the cross-connections by the module 300 actuated by said line.

The AC voltage terminals 305 of the modules 300 are combined to form a second, three-phase terminal 506. In other words, the modules 300 are thus connected in parallel. The power semiconductor switches within the individual modules 300 are here synchronously switched.

The interconnected modules 300 together with the DC link 501 and the power converter controller 503 together form a power converter 500 which can operate as a rectifier or inverter. Its total power is the sum of the power data of the modules 300. Power converters of other power classes may be constructed from a different number of modules 300 or using other types of module 100, 200, 300, 400. DC/DC converters may accordingly be constructed using modules 100, 200, 400.

FIG. 6 shows a schematic structure of a module 100, 200, 300, 400. The module 100, 200, 300, 400 comprises a printed circuit board 101 on which the electronic components are arranged. Conductor tracks of copper or aluminum, which connect the components, are arranged on the printed circuit board 101. The conductor tracks are not shown in FIG. 6. In some embodiments, the printed circuit board 101 comprises an IMS with a metallic substrate and an electrically insulating layer between the substrate and the conductor tracks. The substrate may be formed for example from aluminum or copper. The insulating layer may be for example a ceramic layer or a varnish.

Commutation capacitors 103, power semiconductors 104, and gate-driver circuits 105 for the power semiconductors 104 are arranged in a first region of the printed circuit board 101. Each semiconductor switch 104 may take the form of a discrete electronic element, for example as an SMD element, in which the semiconductor layers are arranged in a package. The electronic elements are attached to the printed circuit board 101 by means of a solder layer, wherein the solder layer may be formed by tin-lead solder.

The solder layer may for example have been arranged on the conductor tracks or on the contact faces of the electronic elements by means of a wave soldering method, and the electronic element soldered together with the printed circuit board 101.

The gate-driver circuits 105 may each comprise a circuit of the kind known as a gate driver. The gate-driver circuits bring about reverse transfer of a gate capacitance on switching of the respective semiconductor switch 104. Connecting discrete semiconductor switches 104 with gate-driver circuits on a common printed circuit board 101 thus permits a lower inductance connection of driver and semiconductor switch. The current-carrying capacity can be adjusted to specific applications by the number of parallelized semiconductor switches 104. The module 100, 200, 300, 400 of FIG. 6 furthermore comprises a communication interface 604, terminals 603 for the DC voltage and terminals for the AC voltage 602. In some embodiments, a cooling interface 601 may be provided on the side remote from the electronic components.

What is claimed is:

1. A power semiconductor circuit comprising:
two DC voltage terminals;
a half-bridge connected between the DC voltage terminals, the half-bridge including two series-connected switchgear units;
wherein each switchgear unit comprises a respective power semiconductor switch or a plurality of parallel-connected power semiconductor switches;
an AC voltage terminal associated with the half-bridge;
a gate-driver circuit associated with each of the switchgear units;
a commutation capacitor parallel to the half-bridge;
a module controller; and
meter for determining the current to the AC voltage terminal;
wherein the half-bridge, the commutation capacitor, and the gate-driver circuit are arranged on a common homogeneous circuit carrier.

2. The power semiconductor circuit as claimed in claim 1, comprising precisely one half-bridge.

3. The power semiconductor circuit as claimed in claim 1, comprising precisely two parallel-connected half-bridges.

4. The power semiconductor circuit as claimed in claim 1, comprising precisely three half-bridges.

5. The power semiconductor circuit as claimed in claim 1, wherein the commutation capacitor has a capacitance of at most 10 μF.

6. The power semiconductor circuit as claimed in claim 1, further comprising a meter for measuring a voltage across the commutation capacitor.

7. The power semiconductor circuit as claimed in claim 1, further comprising thermometer.

8. The power semiconductor circuit as claimed in claim 1, wherein the commutation capacitor and the half-bridge or half-bridges are constructed as a commutation cell.

9. The power semiconductor circuit as claimed in claim 1, further comprising an inductor between the center point of each half-bridge and the AC voltage terminal.

10. The power semiconductor circuit as claimed in claim 1, further comprising a second AC voltage terminal.

11. The power semiconductor circuit as claimed in claim 10, further comprising a filter capacitor between the AC voltage terminal and the second AC voltage terminal.

12. The power semiconductor circuit as claimed in claim 1, wherein the power semiconductor switches are formed by IGBTs or MOSFETs.

13. The power semiconductor circuit as claimed in claim 1, wherein the power semiconductor switches are formed by wide-bandgap semiconductor switches.

14. The power semiconductor circuit as claimed in claim 1, wherein the module controller carries out pulse-width modulation of the half-bridge with a phase and/or output frequency which can be externally specified to the module controller via an interface.

15. The power semiconductor circuit as claimed in claim 1, wherein the module controller includes a serial interface for communication.
